(19) United States
(12) Patent Application Publication
(10) Pub. No.: US 2020/0407911 A1
(43) Pub. Date: Dec. 31, 2020

(54) MULTI-STRAND COMPOSITE FIBER TENSIONING CABLE

(71) Applicant: FUTURE FIBRES, LLC, Alcàsser - València (ES)

(72) Inventors: Samuel WATSON, Newport, RI (US); Jonathan DUVAL, Valencia (ES); Genis HONTORIA, Valbona (ES)

(73) Assignee: FUTURE FIBRES, LLC, Alcàsser - València (ES)

(21) Appl. No.: 16/980,950

(22) PCT Filed: Mar. 15, 2019
(86) PCT No.: PCT/EP2019/056550

§ 371 Date: Sep. 15, 2020

Related U.S. Application Data
(60) Provisional application No. 62/643,383, filed on Mar. 15, 2018.

(51) Int. Cl. D07B 5/00; B63B 17/00; D07B 1/02; F16G 11/02; F16G 11/04

(52) U.S. Cl. CPC D07B 5/005; B63B 17/00; D07B 1/02; F16G 11/025; F16G 11/04; D07B 2201/1004; D07B 2401/206; D07B 2201/1024; D07B 2201/1092; D07B 2201/2017; D07B 2201/2046; D07B 2205/3007; D07B 2201/1016

(57) ABSTRACT

A cable comprising a plurality of fiber composite tensioning elements (1,2) having different mechanical properties into the same bundle wherein at least one of the tensioning elements (1,2) has a different size and shape from the other tensioning elements (1,2) into the same bundle.

This invention relates to the field of sailboat rigging, particularly standing rigging manufactured of carbon or other technical fiber materials. Standing rigging includes the shrouds and stays that keep the mast of a sailboat stable against external loads. Shrouds and stays may feature splits or branches, be continuous or discontinuous, or be single cables or rods. The invention also relates more broadly to fields in which architectural, civil engineering or other structure is supported by or strengthened by a tension element.

### STATE OF THE ART

On sailboats, standing rigging supports spars and other structures using cables and/or rods preferably having a high strength, high rigidity, low weight and low drag coefficient. The weight of the rigging is important, as its center of gravity is high above the deck. If additional weight high above the deck raises the center of gravity of the vessel, the righting moment must be compensated by adding much more weight to the keel. Additionally, lower drag coefficients of the cables increase the performance (i.e., speed). Directly influencing the drag coefficient is the cable section area and its shape. For example, some current systems have aerodynamic shapes in order to minimize the drag coefficient. However, the cost to manufacture these shapes is typically high, because numerous, expensive custom molds are required to manufacture each cable.

Much high-performance standing rigging is manufactured of composite materials mainly carbon fiber mixed with a resin. This material has the advantage that is light, and its strength and rigidity is high.

Standing rigging is commonly made of composite material by two different general methods of manufacturing. According to one method cable is manufactured with numerous fiber composite tension members (rods), typically all with the same tensile strength, such that each supports a portion of the total load. When bundled together and bonded at their ends, the rods will then be able to support the full load of the cable. According to the other method, all of the fibers of the cable are compacted and cured together, creating a single tensioning element.

Each method of manufacture has its advantages and disadvantages. Rigging manufactured of multiple separate tensioning elements has the following advantages: high resistance against impact; safe product, as if some of rods break, the cable will still work and the boat will be able to travel back to the port; and small coiling radius (important for transporting the rigging). Rigging manufactured by the first method also has a disadvantage: such rigging has an increased diameter because there is air between the rods.

Using the second method to form a single solid tensioning element, the advantages are: minimum diameter, as there is no air in the cable; minimum weight (it is not required to use a cover to keep the fibers together). The second method also has disadvantages: the product of this method is more fragile; impact damage is more likely with the product of this method. Products of this second method require a large coiling diameter to avoid damaging the cable during its transport away from its installed configuration, for example as part of a sailboat, making the transport of the cables very difficult, dangerous, and expensive, as special boxes are required.

In the art are known several documents, e.g. U.S. Pat. No. 7,540,250; US2009/0158984; U.S. Pat. Nos. 8,267,028; 8,770,127; 9,120,538; WO2010057167; WO2014060600 and ES2284327. However, none of the cited documents disclose all the features and advantages of the invention.

### DESCRIPTION OF THE INVENTION

The invention discloses a multi-strand composite fiber tensioning element according with the claim 1. In the dependent claims there are disclosed several embodiments of the invention. Therefore, the invention discloses a new concept of strength elements; a new method to organize the fibers in a split Y branch of the cable (spreader (5)); a new method to manufacture the cross-section shape in the rigging industry; and improvements of the existing fittings in the market. The present invention reduces the weight, diameter, section area and drag coefficient in standing rigging, in continuous, discontinuous or single shrouds and stays, with or without splits or branches. They also make standing rigging safer against impacts and make the shrouds easier to handle and coil for transportation.

The invention includes manufacturing a cable comprising multiple fiber composite tensioning members, with some of them having different strength capabilities. This means that some of the tensioning elements can have a different size and shape that others. This difference between tensioning members provide various benefits, achieving a decrease of complete area of the cable, as the amount of air into the bundle will be less.

The cable according with the invention can be composed in different ways; the most common will be when the cable is composed by two families of tensioning elements: the “rods” and the “plate” or “plates”. An additional composition of the cable is by a set of plates compacted together. The term “plate” or “rod” does not restrict the shape of the element.

This invention could be used cover-less, or with any type of covers. For example, in a typical cable that already is in the market, comprised of multiple round tensioning elements, there is a percent of air by volume in the cable bundle. So, in this invention, the fiber contained in the “plate” does not contain any significant amount of air, reducing the amount of air contained in the complete bundle of the cable, consequently, decreasing the cross-sectional area of the cable.

An additional advantage is that by changing the shape of the plates, the outer shape of the cable bundle can be varied. This will help to make more aerodynamic shapes, reducing the drag of the standing rigging. In the current standing rigging in the market, during the production of the rigging, it is required to have an over-wrapping cover or tape, to compact the tensioning elements which reduces the outer diameter and keeps the fibers together during curing or over the working life of the cable. This process creates round shapes. To change the shape to other aerodynamic shapes, sections are required to use numerous molds. For each size and shape of sections of cable, a different mold is required. These molds add cost to the manufacturing process. This invention allows the creation of shapes other than round without any extra tools, as the same plate will create the desired shape dictated by its design.

Additionally, by creating non-symmetrical section shapes, the standing rigging will create lift. This effect will contribute to improve the righting moment of a boat using a shroud having such a shape, so making it faster. This effect will contribute to improve the righting moment of a boat using a shroud having such a shape, so making it faster.

Another improvement achieved with this design versus the products that there are in the market, is the ability to bend the cable without damaging it, which is important during use and set up as it must follow the curves described by the spreaders 5, as well as being coiled during transport and storage. More and more often, standing rigging is sent worldwide from the manufacturing factories to the boats, and also from the boats to the workshops for maintenance or service. So, reducing the cable coiling diameters will save money in each shipment.

To improve the bendability of the cables, from the design point of view, the shape of the plate has to get the lowest inertia in the plane that the cable will be bent, so in that axis the plate will be very flexible. Also, the shape of the plate can vary in different parts of the cable, changing the plane of the lowest inertia. It will allow the cable to bend in different directions along its length.

Another important parameter in standing rigging is impact resistance. Often, during sailing the shrouds get hit transversally by other boat components, including for example the sails, halyards, boom, and spinnaker pole. It is already demonstrated that multi-strand technology resists transversal impacts better than solid cables. Cables manufactured according to the principles of the invention maintain the benefits of using rods. If the cable is hit with enough intensity to break the plate, the mast would remain standing, being supported by the remaining, more flexible, rods. In many instances where a boat would be disabled to the point of requiring a tow, salvage, or other rescue, such impact resistance would allow the boat to travel safely back to port.

Throughout the description and claims, the word “comprises”, and its variations, does not involve the exclusion of other technical specifications, additions, components or steps. For those skilled in the art, other objects, advantages and characteristics of the invention, will be clear partly from the description and partly from the invention in use. The following examples and drawings are provided for illustrative purposes only and are not intended to restrict this invention in any way. Moreover, this invention covers all possible embodiment combinations, particular and preferred, indicated here.

### BRIEF DESCRIPTION OF THE DRAWINGS

A very brief description of a series of drawings follows, which will help to better understand the invention, and which expressly relate to an embodiment of this invention that is presented as non-limiting example of this.

FIG. 1 shows a schematic view of a cross-section of a cable according with an embodiment of the invention.

FIG. 2 shows a schematic view of a cross-section of a plurality of embodiments of the cable according with the invention.

FIG. 3 shows a schematic view of a cross-section of a cable according with a further embodiment of the invention.

FIG. 4 shows a schematic view of a cross-section of a cable according with a further embodiment of the invention.

FIG. 5 shows a schematic view of a non-symmetrical cross-section of the cable according with the FIG. 3 with a rounded cross-section of the cable of the invention according with FIG. 1.

FIG. 6 shows a diagrammatic, stern end view of an exemplary sailboat outfitted with continuous fiber composite tensioning members of the invention.

FIG. 7 shows a schematic view of a cross-section of a cable according with a further embodiment of the invention.

FIG. 8 shows a schematic view of a cross-section of a cable according with a further embodiment of the invention.

FIG. 9 shows a schematic view of a cross-section of a cable according with a further embodiment of the invention.

FIG. 10 shows a front view (outboard) and its section A-A of the cable shown in FIG. 9

FIG. 11 shows a schematic view of a cross-section of a cable according with a further embodiment of the invention.

FIG. 12 shows a schematic front view of the cable shown in FIG. 11

FIG. 13 shows a schematic front view of a further embodiment of the invention.

FIG. 14 shows a perspective view of the end fitting of the cable of the invention.

FIG. 15 shows a schematic cross-section of the end fitting of FIG. 14

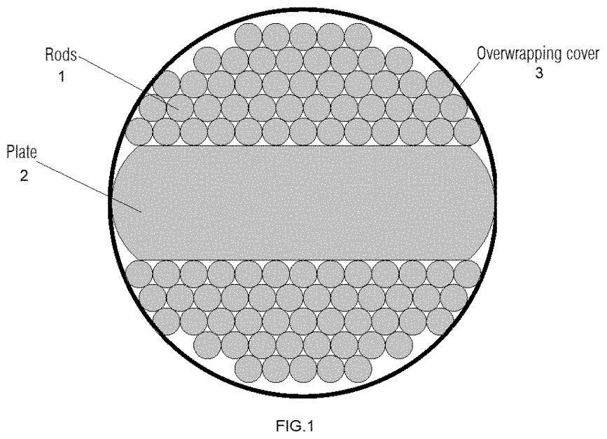

### DETAILED EMBODIMENT OF THE INVENTION AND EXAMPLES

As it is previously explained, the invention includes a cable comprising a plurality of fiber composite tensioning elements 1,2 with at least one of them having different strength capabilities, i.e. different mechanical properties. This means that some of the tensioning elements 1,2 can have a different size and shape from the other ones. This difference between tensioning members 1,2 provide different benefits, achieving a decrease of complete area of the cable, as the amount of air into the bundle will be less.

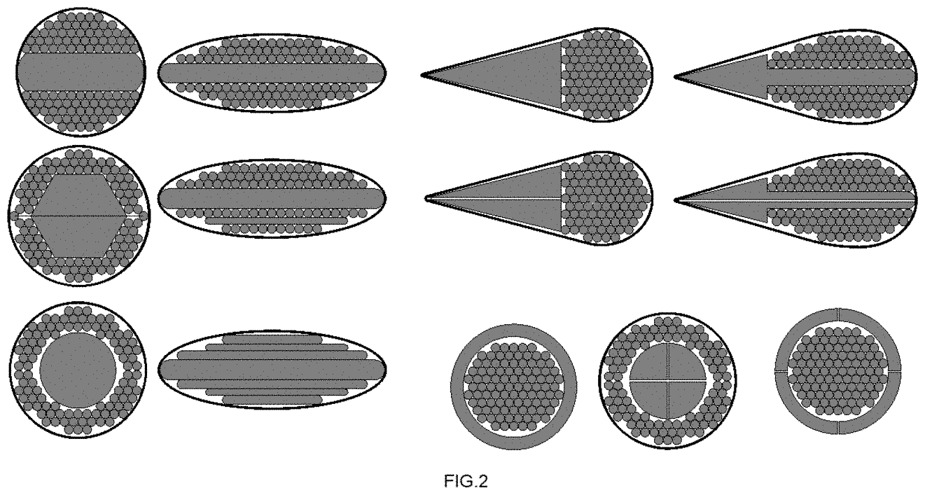

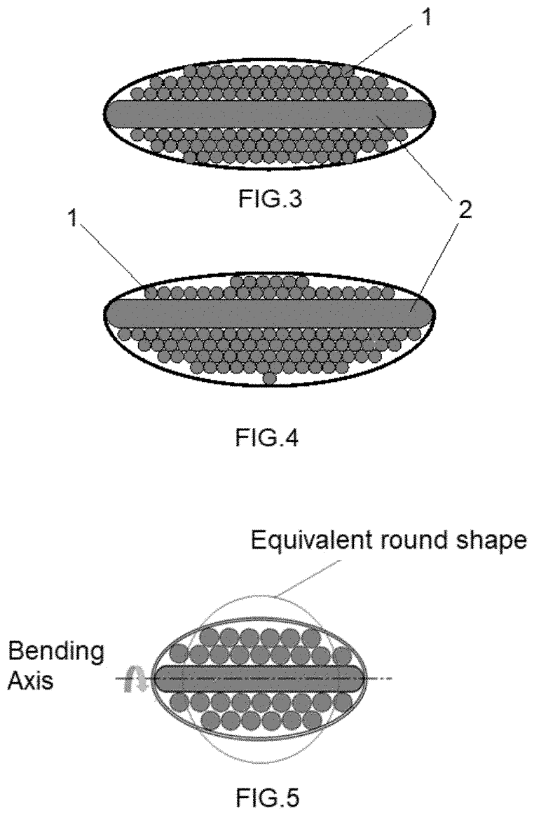

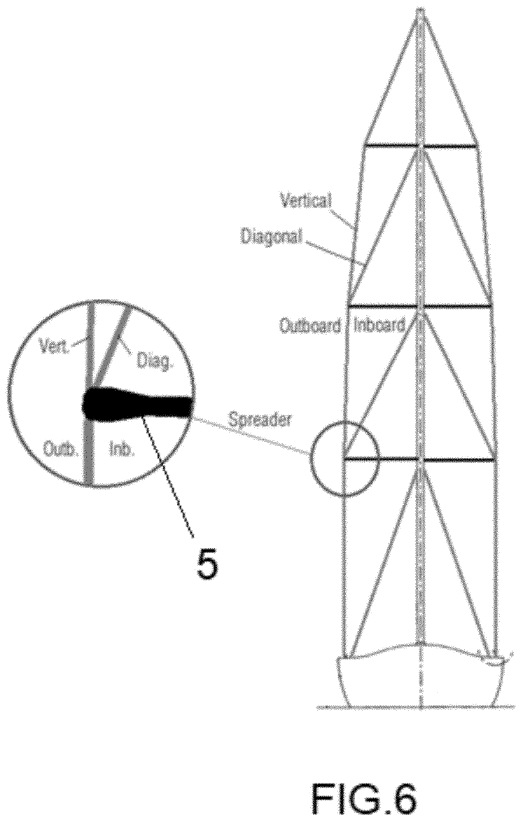

The cable can be composed in different ways. The most common composition is when the cable is composed by two families of tensioning elements 1,2, the “rod” or “rods” 1, and the “plate” or “plates” 2. The other possible way to design the cable is by a set of plates 2 compacted together. However, the terms “plate” or “rod” does not restrict the shape of the respective element, as can be shown in FIG. 2. Nonetheless, the cable of the invention can be used coverless or with any kind of cover 3.

In a typical cable that already is in the market, comprised of multiple round tensioning elements, there is a percent of air by volume in the cable bundle. So, in this invention, all the fibers contained in plate or plates 2 does not contain any significant amount of air inside, thus reducing the amount of air contained in the complete bundle of the cable and consequently decreasing the cross-section of the cable.

Also, another advantage is that by changing the shape of the plates, the outer shape of the cable bundle can vary. This will help to make more aerodynamic shapes, reducing the drag of the standing rigging. In the current standing rigging in the market, during the production of the rigging, it is required to have an over wrapping cover or tape, to compact the tensioning elements which reduces the outer diameter and keeps the fibers together during the curing or over the working life of the cable. This process creates round shapes. To change the shape to other aerodynamic shapes, sections are required to use numerous molds. Notice that for each size and shape of sections of cable, a different mold is required. These molds add cost to the manufacturing process. This invention allows the creation of shapes different other than round without any extra tools, as the same plate will create the desired shape depending in its design. Also, by creating non-symmetrical section shapes, the standing rigging will create lift, as can be seen, e.g. the cable section in FIG. 4. This effect will contribute to improve the righting moment of a boat using a shroud having such a shape, so making it faster.

Another improvement achieved with this design versus the products that there are in the market, is the ability to bend the cable without damaging it, which is important during use and set up as it must follow the curves described by the spreaders 5, as well as being coiled during transport and storage. More and more often, standing rigging is sent worldwide from the manufacturing factories to the boats, and from the boats to the workshops for maintenance or service. So, reducing the cable coiling diameters will save money in each shipment.

To improve the bendability of the cables, from the design point of view, the shape of the plate must get the lowest inertia in the plane that the cable will be bent, so in that axis the plate will be very flexible. Also, the shape of the plate can vary in different parts of the cable, changing the plane of the lowest inertia. It will allow the cable to bend in different directions along its length.

As an example, see FIG. 5 in which an elliptical cross section of the invention is comparted to a conventional round cross section. The minor axis dimension of the elliptical cable is smaller than the diameter of a round cable having the same cross-sectional area, so it will be easier to bend perpendicular to the minor axis of the ellipse than a cable with a round shape, and the bending diameter would be less. Another important parameter in standing rigging is impact resistance. Often, during sailing the shrouds get hit transversally by other boat components, including for example the sails, halyards, boom, and spinnaker pole. It is already demonstrated that multi-strand technology resists transversal impacts better than solid cables. Cables manufactured according to the principles of the invention maintain the benefits of using rods. If the cable is hit with enough intensity to break the plate, the mast would remain standing, being supported by the remaining, more flexible, rods. In many instances where a boat would be disabled to the point of requiring a tow, salvage, or other rescue, such impact resistance would allow the boat to travel safely back to port.

All the tensioning elements should carry loads that equalize the stress on each when the cable is used on the boat. To achieve that, during the manufacturing process the lay out of the tensioning elements must have the same configuration, angles and lengths, that they have when the shrouds are installed in the boat.

With this lay out each tensioning element will have to be tensioned at the same stress. It means that tensioning elements with different amount of fiber will be tensioned with different loads to achieve the same stress.

Every tensioning element, rod or plate, doesn't have to go along the full length of the rigging. The number of tensioning elements in cross-sections at different points along the length of a rigging element can vary. The number of tensioning elements can be varied at arbitrary points along a length of cable by simply adding, modifying, or removing tensioning elements along such a length. This allows the adjustment of the rigidity and breaking load in each section of rigging. Adding or removing tensioning elements can change the shape and the amount of fiber along arbitrary sections of a cable's length, which permits the arbitrary adaptation of the cross-section of the cable along its length.

The tensioning elements can be manufactured in different ways, the most common methods are by pultruding, by winding, or by using laminate fabrics. The tensioning elements can be manufactured straight, twisted or curved in two dimensions or three dimensions. Also, the plate 2 once manufactured could be coiled in or on a drum to be stored as a stock. The length required for a desired cable can then be cut from the drum.

If the proposed invention forms continuous standing rigging, one of the involved parts of this cable are the spreaders 5. In a spreader (5) section, the cable gets split like in a “Y” branch, so part of the tensile elements continues to one branch in vertical direction and the other part bends to the other branch in diagonal. The terms “vertically” and “diagonally” used in this document may be oriented in other directions relative to the sail boat.

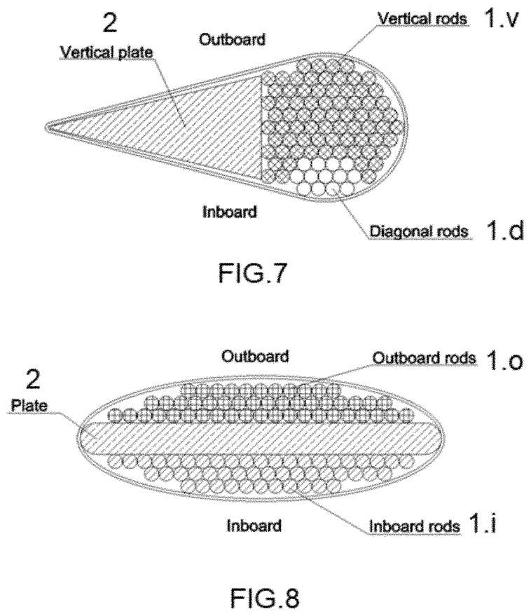

The concept of continuous standing rigging means that the cable does not need couplings or intermediate fittings at the spreader (5). The fibers are continuous in that zone. In this invention, the “plate” or “plates” 2 can go through the spreader (5) up to the vertical, up to the diagonal or up to both. Depending on the shape of the plate 2, there are different options to organize the tensioning elements. In some configurations (e.g. FIG. 7) the plate 2 will not divide the cable in two sides, outboard and inboard, some of the rods 1 or plates 2 easily will be divided in vertical 1.v or diagonal 1.d elements.

In other configurations, the “plate” 2 will divide the cable in two sides, isolating part of the tensioning elements (the rods 1) on one side and another part on the other, outboard rods 1.o and inboard rods 1.i (e.g. FIG. 8).

In the illustrated configuration all the rods extracted from the bundle to create the diagonals will come from the inboard rods 1.i. This means that after each spreader (5), the vertical bundle will have fewer rods in the inboard and keep the same number in the outboard. The relationship between the number of rods in the outboard and inboard changes along the cable length. In addition, this results in an intrinsic change to the cable cross-sectional shape as the length of the cable is traversed.

To solve this issue, another aspect of the invention is that the plate includes a hole or slot 4, allowing rods 1 to pass from the outboard to the inboard. In this way, the diagonal can be manufactured with part of the rods 1 from the outboard and part from the inboard. This design allows a cable to be constructed that maintains the relationship between the number of rods 1 in the outboard and inboard sections constant or in whatever relationship is desired by the rig designer.

The fibers that get branched, creating the diagonal, could be composed by (a) only rods; (b) rods and plate; or (c) only plate. As said above, the plates 2 can change the shape and amount of fiber at any time, that change makes more sense when it branches after a spreader (5). Also, the plate 2 can be manufactured with a curved or twisted shape to help to accommodate it to the final rigging shape, eider if it is in one plane or in three-dimensions.

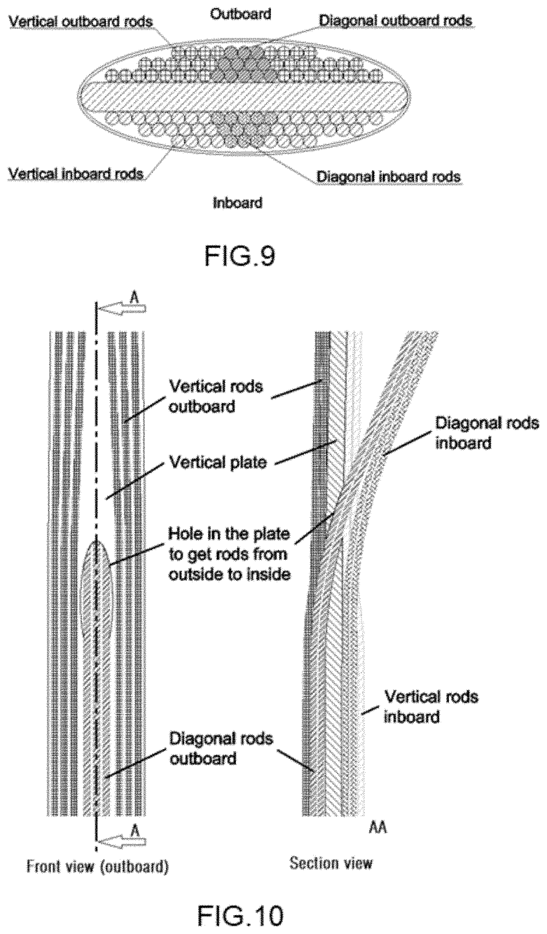

As an example, in FIG. 9 it can be seen the solution proposed for a spreader (5) with the diagonal crated only with rods 1. In the FIG. 10, the section of continuous rigging at the spreader (5) can be seen. It illustrates how the rods 1 placed on the outboard side, cross the plate thru the plate 2 slot and create part of the diagonal. Also, some of the rods 1 from the inboard change direction, creating part of the diagonal. The rest of rods 1 and plate 2, stay in a vertical direction.

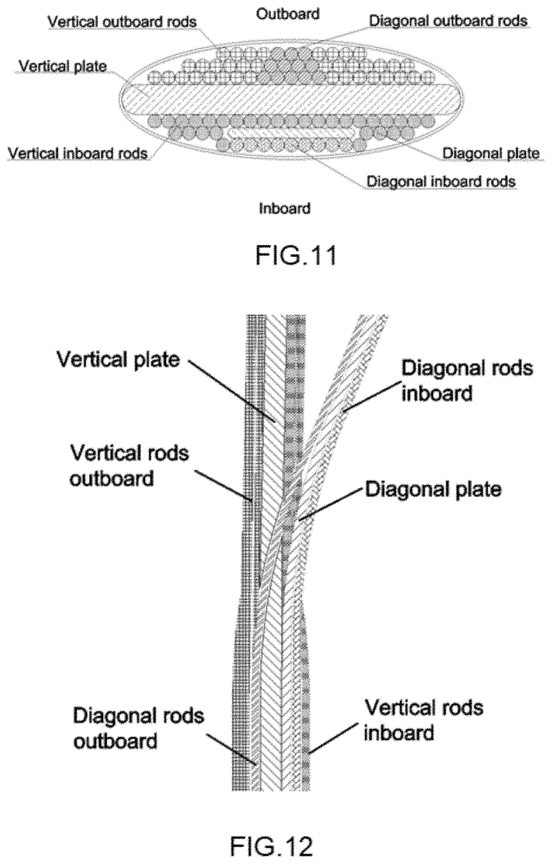

Another solution proposed for a spreader (5) having the diagonal composed of a combination of rods 1 and plate 2 is shown in FIG. 11 and FIG. 12. The difference between the solution of FIGS. 11 and 12 with the solution of FIGS. 9 and 10 is that there are two plates 2 that run up in a vertical direction and the other plate 2 bends around the end of the spreader (5), together with some of the rods 1 to create the diagonal.

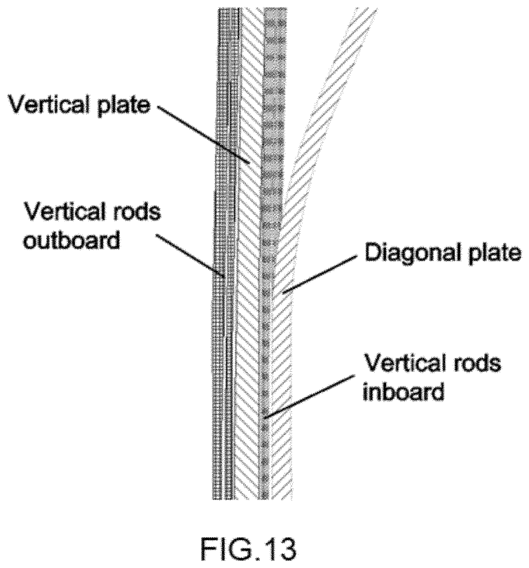

Another novel solution is proposed in FIG. 13 wherein the diagonal above a spreader (5) is formed using only a plate 2, i.e. no rods; all the rods run vertically outboard of the vertical cable. In this case, the FIG. 13 shows how the diagonal is made by just one plate 2 that comes from the vertical.

Another improvement proposed in the invention concerns the end fittings 6. The improvement to the end fittings 6 accommodates existing fittings used in the markets served by the aspects of the invention related to the cable described above. The end-fitting 6 of this invention employs shapes that accommodate the aspects of the cable described above. In the invention, all the tensioning elements, including the rods 1 and plates 2, are bonded together in a mold that shapes a plug on the end of the cable. This plug is fitted into a body. The internal shape of the body matches the outside surface of the plug created on the end of the tensioning elements 1 and 2. The body has features to fasten the body to the desired part of the boat or the mast.

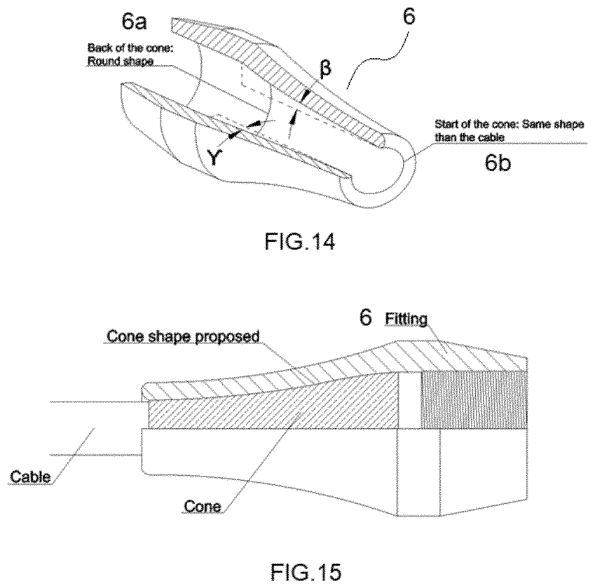

In the invention, the cable could have a cross-section that is not generally round as is the case of the prior art (e.g. U.S. Pat. No. 7,540,250 B2). To optimize the fitting and reduce weight, the end of the fitting through with the cable enters has the same cross-section as the cable. The design can be seen in FIG. 14 and FIG. 15. As shown in the figures, the back of the cone 6a has a round section and the start of the cone 6b has the same cross section as the cable.

In the new proposed fitting 6, as the cone changes along the length from the cable shape to a circle, the angles are variable; γ and β are different, so the stress in the cone will be less homogenous than in a round cone. This results in parts of the cone that experience more stress and other parts that experience less stress. This difference could cause the cable to break at lower loads than one having a comparably-sized round cone. In order to improve the performance of the proposed fitting and in consequence reduce the weight, the invention further includes a change to the cone or frustum-shaped surface to a parabolic cone

This new design decreases the stress in the fitting and plug, producing lower stress values than in the conventional design. Thus, a fitting can be designed to have lower weight, while retaining the strength properties of the conventional design. Also, the invention proposed can use other types of terminations, including spool continuous winding and others.

1. A cable comprising a plurality of fiber composite tensioning elements having different mechanical properties into the same bundle wherein at least one of the tensioning elements has a different size and shape from the other tensioning elements into the same bundle.

2. The cable according with claim 1 wherein fiber composite tensioning elements are composed by at least a rod and at least a plate.

3. The cable according with claim 2 wherein the fiber composite tensioning elements are composed by a plurality of rods and a plurality of plates.

4. The cable according to claim 1 comprising a set of plates compacted together.

5. The cable according to claim 1 wherein the tensioning elements are composed of dissimilar materials.

6. The cable according to claim 1 wherein it can be used coverless or with any kind of cover.

7. The cable according to claim 1 wherein the fibers contained in the plate or plates does not contain any significant amount of air inside.

8. The cable according to claim 1 wherein the outer shape of the cable bundle is not symmetrical.

9. The cable according to claim 1 wherein the shape of the plate or plates vary in different parts of the cable along its length, changing the plane of the lowest inertia.

10. The cable according to claim 1 wherein the fibers of the tensioning elements are tensioned at the same stress irrespective of the number of fibers that compose each one of the tensioning elements.

11. The cable according to claim 1 wherein the cross-section of the cable along its length can be adapted by adding or removing tensioning elements that can change the shape and the amount of fiber along arbitrary sections of the cable's length.

12. The cable according to claim 1 wherein the plate or plates includes a hole or slot allowing rods to pass thru.

13. The cable according to claim 1 wherein the end-fitting body being cone-shaped; wherein the start of the cone has a cross-sectional shape which is the same as the cross-sectional shape of the cable except that it is enlarged uniformly to allow the cable to enter the cone.

14. The cable according to claim 1 wherein the end-fitting body being cone-shaped; wherein the back of the cone has a section which differs in shape from the cable and the start of the cone has the same cross section as the cable; and wherein the internal angles are different.

15. The cable according to claim 1 wherein the tensioning elements or any of their constituent parts are made to create a loop or opening at the cable's end, such as by winding or wrapping around a mold or form, wherein this loop can be used to apply a load to the cable.
